(19) United States
(12) Patent Application Publication
(10) Pub. No.: US 2026/0111794 A1
(43) Pub. Date: Apr. 23, 2026

(54) METHODS, ARCHITECTURES, APPARATUSES AND SYSTEMS FOR DISTRIBUTED ARTIFICIAL INTELLIGENCE

(71) Applicant: InterDigital CE Patent Holdings, SAS, Paris (FR)

(72) Inventors: Stephane Onno, SAINT GREGOIRE (FR); Cyril Quinquis, MELESSE (FR); Thierry Filoche, CHATEAUGIRON (FR); Francois Schnitzler, SAINT AVE (FR)

(21) Appl. No.: 19/126,413

(22) PCT Filed: Nov. 3, 2023
(86) PCT No.: PCT/EP2023/080639

§ 371 Date: May 1, 2025

(30) Foreign Application Priority Data
Nov. 4, 2022 (EP) 22306669.7

(51) Int. Cl. G06N 20/00; H04N 21/466; H04N 21/658; H04N 21/845

(52) U.S. Cl. CPC G06N 20/00; H04N 21/466; H04N 21/6582; H04N 21/8456

(57) ABSTRACT

Procedures, methods, architectures, apparatuses, systems, devices, and computer program products for distributed Artificial Intelligence, AI. A first device partitions a unit of media data corresponding to a media content item into a plurality of media segments, and, for each media segment, determines a machine learning model, a machine learning part, and whether inference using the machine learning part is to be performed externally to the first device or by an inference unit of the first device, transmits content data corresponding to the media segment and information indicative of the determined machine learning model and machine learning part for inference, and obtains processed data resulting from processing of the content data using at least the machine learning part.

### CROSS-REFERENCE TO OTHER APPLICATIONS

This application claims the priority to European Application No. 22306669.7, filed Nov. 4, 2022, which is incorporated herein by reference in its entirety.

### BACKGROUND

The present disclosure is generally directed to the fields of communications, software and encoding, including, for example, to methods, architectures, apparatuses, systems directed to collaborative Artificial Intelligence (AI).

### SUMMARY

In a first aspect, the present principles are directed to a method comprising, in a first device, partitioning a unit of media data corresponding to a media content item into a plurality of media segments, and, for each media segment, determining a machine learning model, a machine learning part, and whether inference using the machine learning part is to be performed externally to the first device or by an inference unit of the first device, transmitting content data corresponding to the media segment and information indicative of the determined machine learning model and machine learning part for inference, and obtaining processed data resulting from processing of the content data using at least the machine learning part.

In a second aspect, the present principles are directed to a first device comprising at least one hardware processor configured to partition a unit of media data corresponding to a media content item into a plurality of media segments, and, for each media segment, determine a machine learning model, a machine learning part, and whether inference using the machine learning part is to be performed externally to the first device or by an inference unit of the first device, transmit content data corresponding to the media segment and information indicative of the determined machine learning model and machine learning part for inference, and obtain processed data resulting from processing of the content data using at least the machine learning part.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates different examples of splitting of an AI/ML model;

FIG. 3 illustrates examples of split topologies where the UE ingests sensing/media data and acts as an uplink data source;

FIG. 4 illustrates a flow chart of a method of UE content processing in a distributed AI/ML environment;

FIG. 5 illustrates an example system according to an embodiment of the present principles;

FIG. 6 illustrates an example of inference according to an embodiment of the present principles; and

FIGS. 7A-7C illustrate an embodiment of data flow of the example illustrated in FIG. 6.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

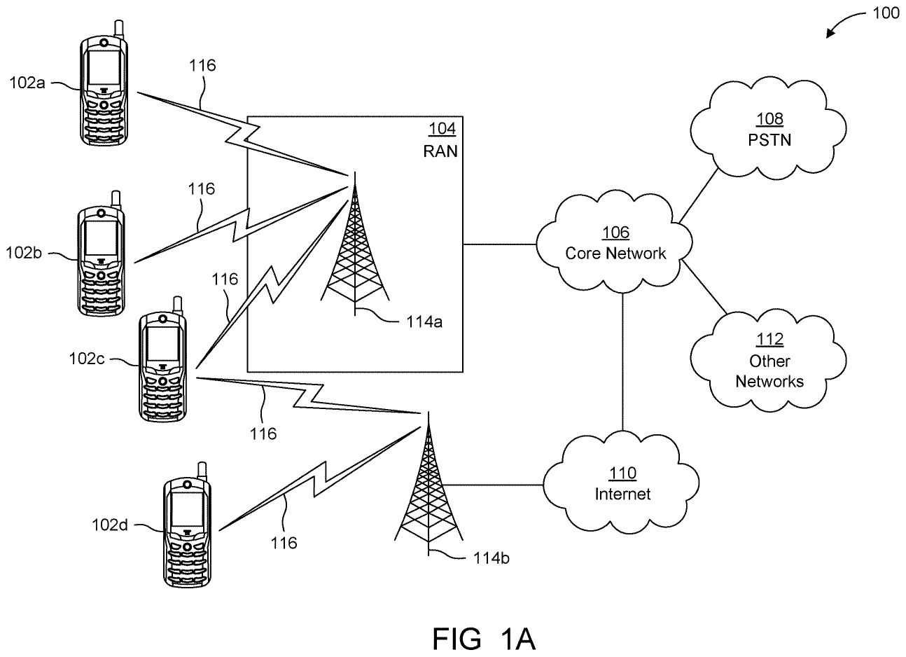

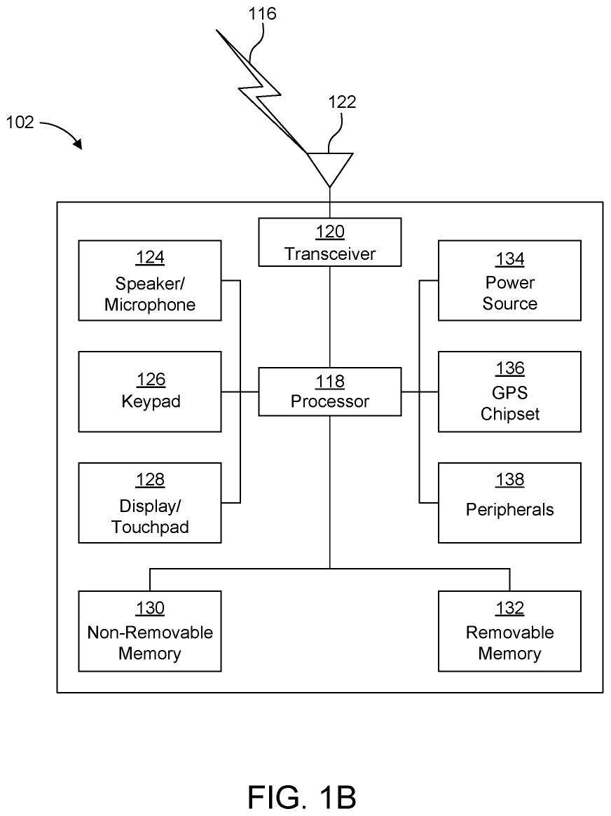

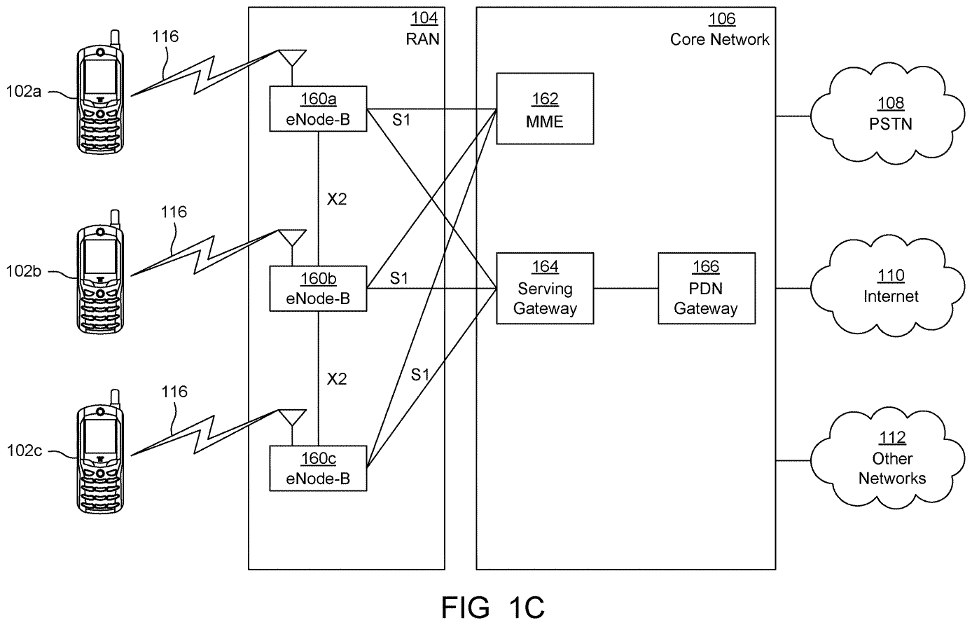

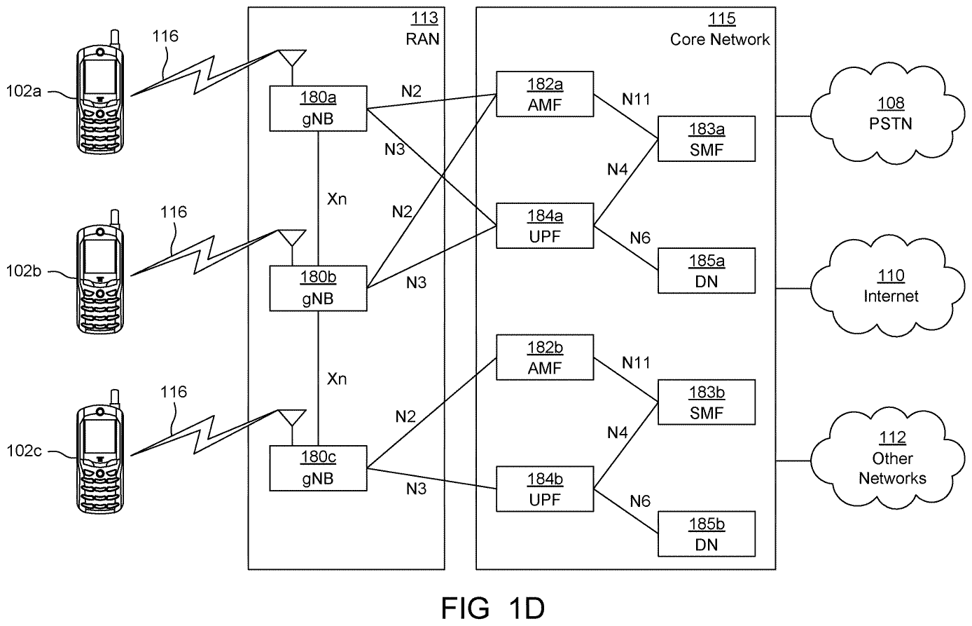

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHZ bandwidths in the TV white space (TVWS) spectrum, and 802.11ah supports 1 MHZ, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-a, base stations 114a-a, eNode-Bs 160a-a, MME 162, SGW 164, PGW 166, gNBs 180a-a, AMFs 182a-a, UPFs 184a-a, SMFs 183a-a, DNs 185a-a, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

While Artificial Intelligence (AI), in particular Machine Learning (ML) can be a very powerful tool in various devices, it will be understood that the resource (e.g. processing) requirements can be too big for devices with relatively limited resources. Such devices, in this description denoted UEs, can be end user devices, in particular mobile devices such as smartphones and tablets. For this reason, it is a common solution to let one or more other devices perform at least part of the calculations. It is noted that ‘device’ (also called ‘node’) in this context may mean a plurality of devices acting as one, for example in the case of server banks and cloud computing.

Apart from being done on a single device, AI/ML inference can thus be divided (i.e. split) over different points (e.g. from UEs to Edge or Cloud devices) for a certain AI/ML application that for example may be based on a Deep Neural Network (DNN). The AI/ML application may for example be split along the interface between two layers in a DNN, or between different parts where one (e.g. a part detecting facial features) can provide a result as input to a following part (e.g. using detected facial features to a person's mood). The corresponding AI/ML model, i.e. the computer program (e.g. trained, i.e. with proper parameters), can thus be split into several AI/ML model subsets to be run on different devices/servers. Each AI/ML model subset is a piece of independent software to run on a split node such as for example a UE, an Edge device, in the Cloud or in an Access Network.

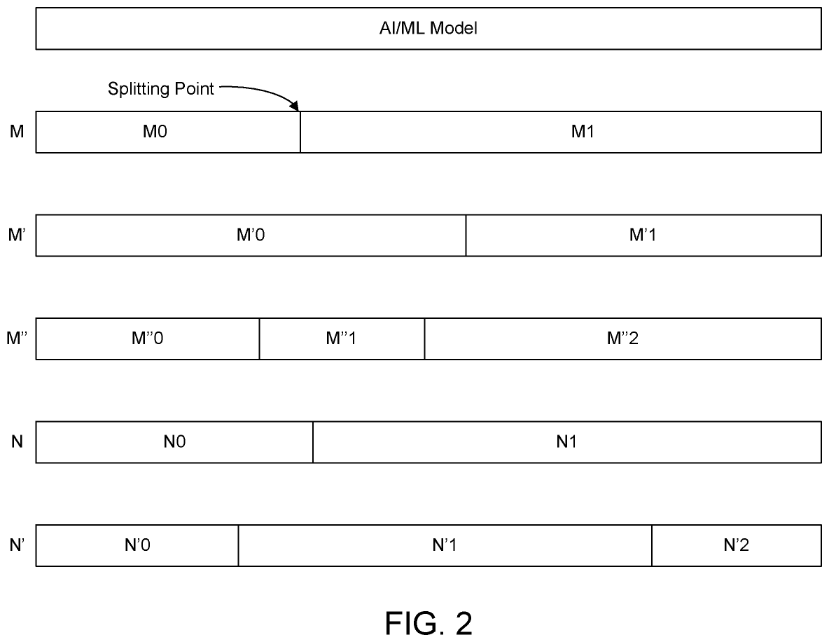

FIG. 2 illustrates different examples of splitting of an AI/ML model. An example AI/ML model can be split in different ways. For example, split model M can include AI/ML model subsets {M0, M1}. Similarly for split model M′ can include {M′0, M′1} and split model M″ {M0″, M1″, M2″}. These three examples of split models M, M′, M″ provide the same service and, as can be seen, can be split into a different number of subsets. The border between different subsets will be referred to as a splitting point (split point, partition point), indicated by an illustrative arrow in one instance. Similarly, another model M can include AI/ML model subsets {N0, N1} while a model N′ can include {N′0, N′1,N′2}. The Model M and N can have the same DNN layers composition with same split points, but they may differ for example, in the weight values of the neurons, the bias values, or the quantization level of any input value.

In addition, different subsets can run or be intended to be run on different devices. Which device a subset runs on can depend on different conditions. Example conditions include device capabilities, device load, and network load. A specific subset, say M0, can thus for example run either on an edge device or on the UE.

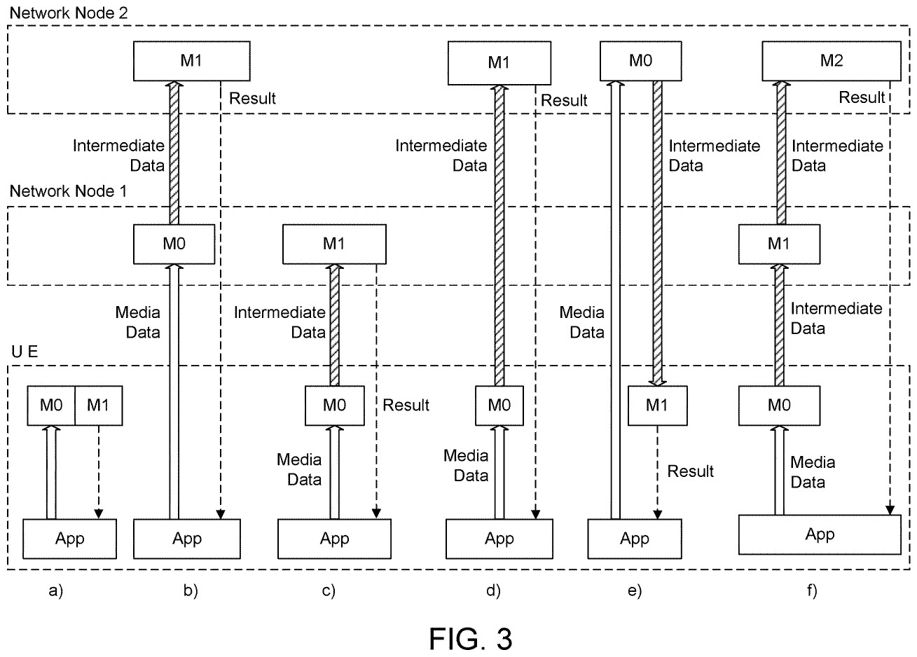

FIG. 3 illustrates examples of split topologies where the UE ingests sensing data and acts as an uplink data source.

It is assumed that the AI/ML model subsets have been obtained (e.g. downloaded, streamed) from a device such as a cloud or edge server node. The media data is provided by the UE (e.g. an application that captures video) to subset M0. In the examples, it is assumed that M0 processes the media data and outputs intermediate data to subset M1. M1 can process (i.e. infer) the AI data to obtain a result or forward different AI data to M2, which in turn processes the different intermediate data to obtain a result. The result is returned to the UE, possibly via the subset with an immediately lower number (e.g. M1 may provide the result via M0). The result can be provided to the application or be used directly by the UE.

In example (a), both M0 and M1 reside on the UE. The UE may run the subset M0 while downloading the other subset M1 and, depending on the model architecture may obtain a first partial result.

In example (b), M0 resides on a first network node (e.g., edge node) and M1 on a second network node (e.g., cloud node).

In example (c), M0 resides on the UE and M1 resides on the first network node.

In example (d), M0 resides on the UE and M1 resides in the second network node.

In example (e), M0 resides on the second network node and M1 resides in the UE.

In example (f), M0 resides on the UE, M1 resides on the first network node, and M2 on the second network node. The network (edge/cloud) delivers the final result back to the UE upon completion of the successive model subsets.

The result can be rendered in various ways, for example as a video or as a textual piece of information. It can be a textual indication of the recognized object, an output score, a bounding box, or enhanced media data.

The present principles are concerned with split topologies with UE endpoints as source of media streaming data where the result is delivered on a media sequence basis from network/edge endpoints, for example providing enhanced video (e.g., removing artefacts) or video overlay (e.g., pose detection, pedestrian detection). Considerations to take into account include one of more of the following.

### Partitioning Model Depending on UE Constraints and Requirements

The partitioning of the model can depend on one or more of the processing capabilities of the UE, the current network conditions, and the remote network processing capabilities. These capabilities and conditions typically vary over time and can impact the application-level requirements, for example to guarantee the expected end-to-end latency starting from the media capture to obtention of the result or to guarantee a quality of the result.

### Partitioning Decision Model Distribution

The distributed model executing inference from a single media stream can be suboptimal in case a particular piece of content can be processed only after the previous piece of content has been processed. As a result, the media stream can be paced at a certain frequency. On the other hand, the AI/ML model can handle a limited number of data packets in a unit of time. In this context, the AI/ML model may not correctly absorb (i.e., process) the media stream data, and this may result in slowing down the processing. Such processing issues can increase if the media rate of an input piece of content is greater than the model subset inference media rate of a current piece of content in the UE. For example, the video can stall, or more jitter can be observed in the network.

### Content Aware Dependence of Model Processing

The media (i.e., content) data capture in the UE feeds the model to process, which may be split between the UE and the network. The input content may have distinct characteristics. For example, a camera may take long video shots while nothing happens, or short intensive video shots with much movement. As another example, the light conditions of a video sequence can evolve from dark to bright or the other way around. Depending on characteristics of the content, the requirements on the execution of the model may vary. This can result in different models and/or subsets, for example UE only or distributed over the UE and the network.

### Multiple Media Data Input

A mobile device UE may capture a video stream and an audio stream where both streams are inputs for one or more model inferences. As an example, a robot or a drone UE may capture several media content items at a time. The model and/or the subset—e.g., only UE, only network or distributed among UE network—can depend on for example the number and the type of content.

### Sequential Order Issue

A partitioned model can be managed thanks to model distribution topologies. However, as these topologies may change dynamically, it may be that intermediate data packets are not sequentially transmitted to the network.

### Overview

According to the present principles, a UE can provide (input) content segmentation adapted for model inference, content aware decision to select and distribute the model execution, and scalable and self-contained segment delivery adapted for content data or intermediate data.

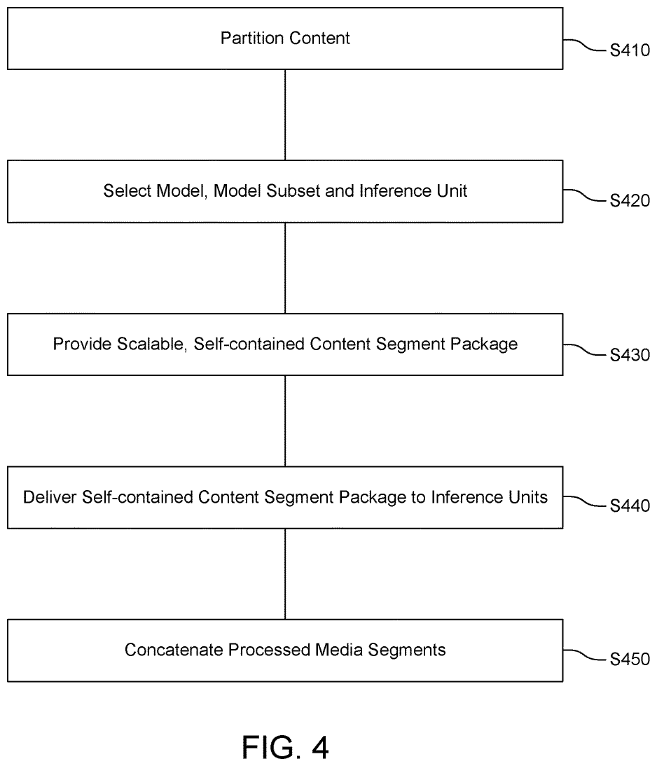

FIG. 4 illustrates a flow chart of a method UE content processing in a distributed AI/ML environment.

In step S410, the UE partitions input content adapted for model inference into variable media segments including inference processing assistance information.

The UE can partition input content into variable segments adapted to feed an inference engine that executes a model subset on these segments. A preprocessing unit (e.g., a processor) in the UE can analyse the content (audio, video) and partition the content into segments to adapt it to the expected inference processing stage.

The UE segmentation unit detects variations that may impact inference. The UE segmentation may provide segmentation information used for inference. The segmentation information may include one or more of: light information, content shot information, number of persons/objects, video plan composition/change, segment dependence, and plan characteristics.

Light information may for example include information on the brightness of the image(s). The model to apply (bias, Weights) may differ based on the light characteristics of the segment.

Content shot information may indicate long shots with little action, or short intensive video shots. The model may easily compute a long duration segment where not a lot happens while it may be more difficult to compute a shorter video segment with much activity.

Number of persons/objects in a plan can indicate the number of persons and/or objects in the shot. The number of computation units can vary depending on the number(s).

Video plan composition/change information: model execution can be more efficient, and the quality may be higher in case the whole video plan is processed.

Segment dependence information. A segment, and thus the processing, may depend heavily on a previous (e.g., immediately preceding) segment. For example, there may be cases where the segmentation does not correspond to a fully independent frame boundary. In such a case, the current segment may preferably be processed by the same inference engine, executing the same model subset, as the segment it depends on.

Plan characteristics information may for example indicate orientation, resolution, frame.

Based on the information, the content-aware segmentation unit can partition the input content into segments of different duration and/or size.

In one embodiment, the segmentation unit only considers content-related considerations as described above. The segmentation unit may provide the segment and corresponding segment metadata to a local decision module in charge of deciding how to configure the model to process the segments. The segment metadata can include information for the model selection, and estimated processing resources to process the segment.

In one embodiment, the application can configure media segmentation characteristics, range, or limitations, for example, regarding media segment duration, bit rate or segment size minimum, average and maximum.

In one embodiment, the segmentation unit can include the selection (see below). To that end, monitoring information on current UE or network endpoint and network conditions can also be considered for the segmentation itself.

In one embodiment, the UE can deliver the inference processing assistance information to inference units located on network endpoints. This can for example be the case when the media segment is first processed on the network side.

In step S420, the UE selects the model, the model subset and the inference unit adapted to the input media segment.

The UE may select the model, the model subset and the inference units that process the input media segment for each model subset. For each given input content segment, the UE performs one or more actions.

The UE may compute input information. This information may for example include one or more of segmentation unit information, UE or Network capabilities and current network conditions, inference unit list and capabilities, application-level requirements, model characteristics information, and user or task specific requirements, which will be further described.

Segmentation unit information has already been described.

UE or Network capabilities and current network conditions. For example, depending on the initial configuration settings, this can include the required processing power to compute a particular type of segment depending on the size and the complexity. The information can also include an indication of the current network congestion information.

Inference Units list and capabilities. The UE and network can provide a list of inference units with different processing capabilities. As an example, an inference unit (UE or Network) may be adapted to process a particular subset of a given model, for example low processing power, while another unit is more adapted to process other model subsets. As another example, the UE may select a local inference unit for an incoming current segment instead of a network segment if the network is congested.

Application-level requirements. For example, the user or the application may provide information on the processing power allocated for AI/ML processing for all inference units in the UE. The information may vary in response to events; for example, the start of another application may result in less processing power available for the AI/ML process, and the UE may for example select a network inference unit instead of a local inference unit to fulfill the requirements.

Model characteristics information indicates whether the model needs split inference with a task-specific model running on the UE or on the network as a first subset or the final subset.

User or task specific requirements. For example, it may be necessary to perform processing tasks on the end device to preserve privacy or because the tasks are sensitive to delay.

The UE may select the model to apply from a list of models. Different models can be generally the same with different internal compositions (e.g., neurons, weights, bias, quantization).

The UE may select the topologies to be used for the segment which can be UE inference, network inference or split inference unit. For the latter, the decision module selects the UE subset and the network subset distribution to apply.

The UE may encapsulate the information as input to a selected inference unit. A selected inference unit can be one of several UE inference units, or one or several network inference units. The data payload may be media data when the whole model is processed in the network or intermediate data delivery information when a subset is processed by a device.

The UE may mediate the delivery of the segments from the segmentation unit to the selected inference unit in the UE or in the network.

In step S430, the UE provides a scalable, self-contained content segment package.

The UE may encapsulate the information for any inference unit running in any network endpoint to run the remaining network model subset for a given content segment. This allows to start processing a new segment in one inference unit instead of waiting for the completion of the previous segment in another inference unit, including UE inference unit. The network endpoint receives and computes information on how to process the input inference data or intermediate data from any UE. Information can include one or more of the following elements that will be further described: model identifier, originated content identifier, full model, model split point, inference unit information, content segment number, UE identifier, content segment information, segment data payload type, segment data payload compression profile, compression information, and segmentation information.

Model Identifier indicates the trained model in use for the given content segment.

Originated content identifier identifies the input originated content flow. This may be required when a plurality of UE endpoints or network endpoints run a model inference subset from the same originated content. This may be required to identify one content flow when the UE captures a plurality of content flows.

Full model indicates that the UE or the Network will process a full model.

Model split point indicates one or more points that separates an AI/ML trained model into two or more subsets, each including a set of different layers. The UE selects the model subsets to run on the UE or in the network based on the model split point indication.

Inference unit information identifies an inference unit. In an embodiment, the package can be sent/received/forwarded by dedicated package delivery/access in charge of routing the segment package depending on this information and further information of the package.

Content segment number is a counter used to keep track of processed segments. The number can be used to reorder processed segments in the network or in the UE.

UE Identifier. The network may require the UE identifier to reassemble the content segment output resulting from a network endpoint inference for delivery to the identified UE.

Segment data payload type indicates if segment data is media content or intermediate data resulting from processing a subset of an AI/ML model.

Segment data payload compression profile. In case the delivery function applies compression techniques before delivering the segment payload, this information may indicate the corresponding compression information. It includes the necessary information for encoding/decoding the data payload of the segment.

Content segmentation information, already described. This information can be particularly useful when the UE decides to fully offload the process of a segment to the network

Data payload information can be transmitted in different ways. For example, information elements may be already known at the configuration stage. These can include the compression technique that is used between a UE and the network. A bitstream can contain information elements in a specific header or in separated timed information channel.

In one embodiment, the UE may package the intermediate data for internal UE inference units, for example where inference units are independent processes, VM or hardware resources. In addition, when a UE has processed a first model subset, it may update the received information of the input segment package to produce a new modified package comprising the information required to process the next subset that will be sent to the next inference unit.

In one embodiment, the scalable and self-contained content segment package encapsulation includes result data information, e.g., a textual indication of a recognized object, an output score, a bounding box, or enhanced media data information. When the result data information is media data, the segment data payload includes the processed media data and the encapsulation includes result metadata useful to process the media data.

In step S440, the UE delivers self-contained content segment package to inference units in the UE or to the network. In an embodiment, the UE provides intermediate data to local inference units. The inference units in the network can be located in other remote endpoints, such as in the network or other UEs.

The UE and the network provide scalable inference units able to process the self-contained content segment. An inference unit may be an independent process that runs the inference on a part of a model for a given input segment. It may be an internal hardware device, e.g., an allocated TPU, GPU, CPU, or a software process or, a Virtual Machine instance running on the UE or on the network. Such a hardware device may run a plurality of inference units.

The inference unit receives the self-contained content segment including related information on the model subset to apply, performs the inference of the model subset for the segment, and updates the self-contained segment information. For example, if the UE has just processed a subset, it may update the information for applying the next subset.

The inference unit then sends the processed segment to the next inference unit according to the updated self-contained segment information.

In one embodiment, the inference unit receives or sends the content directly.

In one embodiment, the inference unit receives or sends content segment from a delivery, or an access function devoted to mediating the segment between inference units located in the UE or in the network. The access/delivery function can be seen as a network forwarder.

In another embodiment, for example illustrated in FIG. 3, use-case e), where the UE receives intermediate data from the network (edge/cloud), inference units on the network side send the self-contained segment including the intermediate data. To that end, they may send the segment to the delivery function in the network for encapsulation and transmission of an updated self-contained content package to the UE.

In another embodiment, for example illustrated in FIG. 3, use-case b), where one or more model subsets are processed between nodes of the network side, e.g. one edge node and one cloud node, the edge or cloud node may provide an access/delivery function to send the self-contained segment including intermediate data to other node. For example, in use-case b), the edge node having processed the segment from a first subset sends the self-contained content segment including intermediate data to the cloud node for processing the next subset.

In step S450, the UE reorders, if needed, and concatenates processed media segments received from different inference units belonging to one or more network endpoints or from the UE.

In one embodiment, the UE receives, reorders, and concatenates the processed segments. The UE can make use of package information such as segment number to reassemble and reorder segments processed from possible different inference units provided from different network endpoints or from local inference unit(s) of the UE.

In one embodiment, a network delivery function may reorder whole or part of the processed segment in the network.

In one embodiment where the result is not media, a partial result of a different segment is reorganized inside the UE.

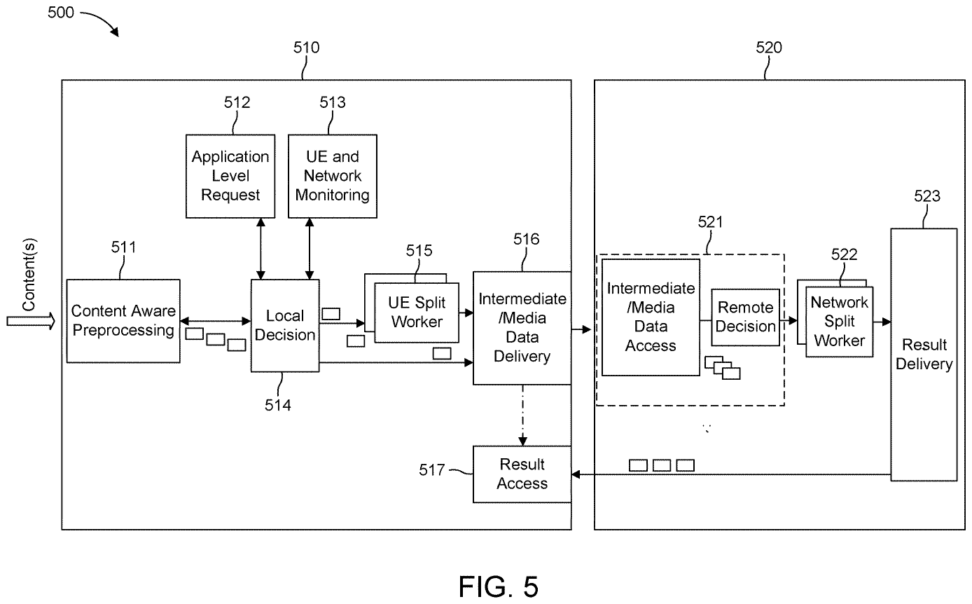

FIG. 5 illustrates an example system 500 according to an embodiment of the present principles. The example system includes a UE endpoint 510 and a network endpoint 520, but it will be understood that more endpoints of either kind may be involved. In the example system, the modules are functional units that can be implemented in one or more processors.

The UE endpoint 510 includes a content-aware preprocessing module 511, an application-level request module 512, a UE and network monitoring module 513, a local decision module 514, one or more UE split inference module 515, an intermediate data delivery module 516 and a result access module 517. The network endpoint 520 includes an intermediate data access and remote decision module 521, a network split inference module 522 and a result delivery module 523.

The content-aware preprocessing module 511 is configured to preprocess received content(s) 530 to provide a segment of media data and information on how to process a media segment. The information may contain model information (which model to use according to the current environment), segment duration, and segment bit rate for a particular duration. The content-aware preprocessing module may receive information for input configuration from the local decision module 514 requesting segment characteristics.

The content-aware preprocessing module 511 can provide a flow of data segment, each data segment is seen as a chunk of media data, media segment characteristics (e.g., duration, bit rate, data size), media specific information and composition (e.g., video coding standard, full video segment or video slice), segmentation information (already described), and segment dependence information (e.g., on which other segment the present segment depends).

The UE and network monitoring module 513 monitors UE capabilities and current network conditions and, depending on the initial configuration settings, provides information on required processing power to compute a particular piece of content and information on network congestion.

The application-level request module 512 provides information on processing power allocation to the AI/ML application. For example, when the application level starts or stops another process, the application-level request module 512 may update the remaining processing power.

The UE split inference module 515 is an independent process that runs the inference on a part of a model for a given input segment. As mentioned, the module may be an internal hardware module, e.g., an allocated TPU, GPU, CPU, or a software process or an Internal Virtual Machine instance running on hardware. The module, which can be said to be stateless, receives the content segment and information on which part of the model to use for the input segment. The content segment and the information may come from the local decision module 514. Upon completion of whole or part of the model, the module 515 sends the processed segment (i.e., output) to the intermediate data delivery module 516.

The intermediate data delivery module 516 encapsulates the information of each given independent segment in a data structure for one or more network endpoints to apply the remaining part(s) of the AI/ML model. In case the entire model is processed by the UE 510, the data delivery function sends the processed segment to the result access function 517.

The intermediate data access and remote decision module 521 receives the output of the intermediate data delivery module 516 of the UE 510, and determines the one or more network split inference module 522 for delivery of the processed segments (i.e., received output).

The network split inference module 522 processes the segments received from the intermediate data access and remote decision module 521 to obtain one or more results that it sends to the result delivery module 523.

The result delivery module 523 collects individual segment results, which it may reorder, before delivery to the result access module 517 of the UE 510.

The result access module 517 receives the segment results, which it may reorder if it is not already done and, delivers the segments to the application. It is noted that the result access module 517 can receive segment results from one or both of the intermediate data delivery module 516 and the result delivery module 523.

The local decision module 514 can compute input information from the content-aware preprocessing module 511, the application-level request module 512 and the UE and network monitoring module 513, select a UE Split model configuration for each content segment, encapsulate the information for input to the one or more UE split reference module 515 or to one or more network split inference modules 522, and mediate the delivery of the segment to the UE split reference module(s) 515 or the intermediate data delivery module 516.

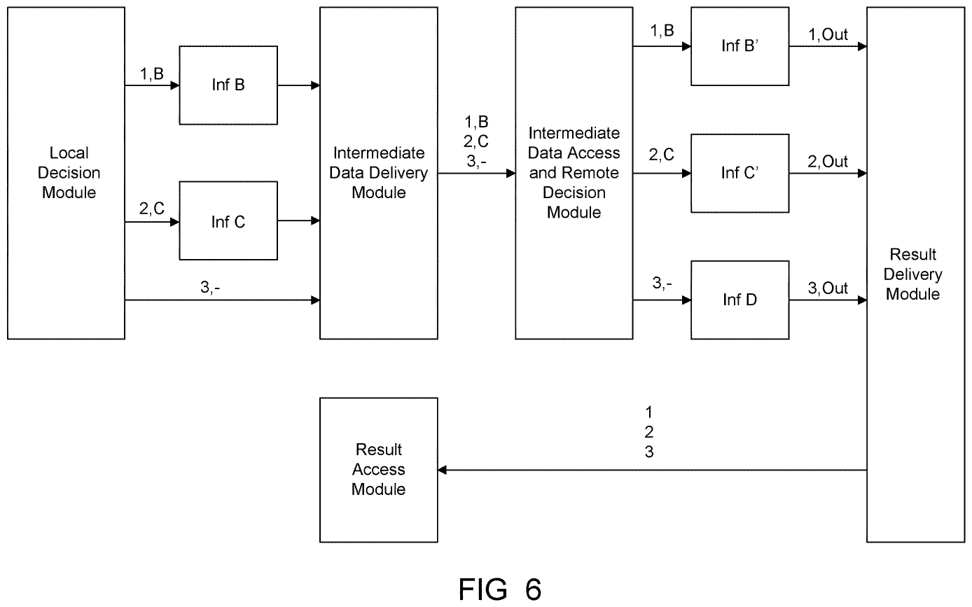

FIG. 6 illustrates an example of inference according to an embodiment of the present principles. Video content is input to the content-aware preprocessing module that outputs three segments: segments 1, 2 and 3. Based on information from the application-level request module and the UE and network monitoring module, the local decision function allocates segment 1 to an inference module B indicating to process a model up to split point B. Similarly, it allocates to inference module C segment 2 to process up to split point C. Then, for a given reason (e.g., required processing power) segment 3 is forwarded to the delivery encapsulation module for transmission to the network to apply the whole model on it or a variation of the model.

Intermediary results from inference modules B and C are delivered to the delivery encapsulation module, which encapsulates the segment data with a metadata header that can include a timestamp. In addition, each intermediary result and unprocessed segment can have a header (or other associated information). The header information includes the information to produce a stateless segment to process and can include information received from inference modules or the local decision function modules, for example UE ID, content ID, model ID, split point ID and segment number identifier. The delivery encapsulation module sends the encapsulated data to the network side.

The encapsulated data includes segment data and metadata, and is self-contained for being processed by network inference modules in a stateless way.

In the network, the intermediate data access and remote decision module receives the encapsulated data, decapsulates the header(s), and forwards the processing information to relevant network inference modules to apply the remaining model part starting for the received split point indication.

In the example, the output from UE inference module B is sent to network inference module B′, the output from UE inference module C is sent to network inference module C′, and segment 3 is sent to network inference module D.

Upon completion, the network may rearrange the results before delivery to the UE (not illustrated).

UE and network endpoints may communicate over a control plane to agree on a configuration to use. The endpoints may for example agree on the one or more models to distribute, the one or more distributed topologies to use, for each model, in case of split inference, the list of split points available on the UE side, the identification of the UE or network endpoints to send or receive data, and the identification of the content.

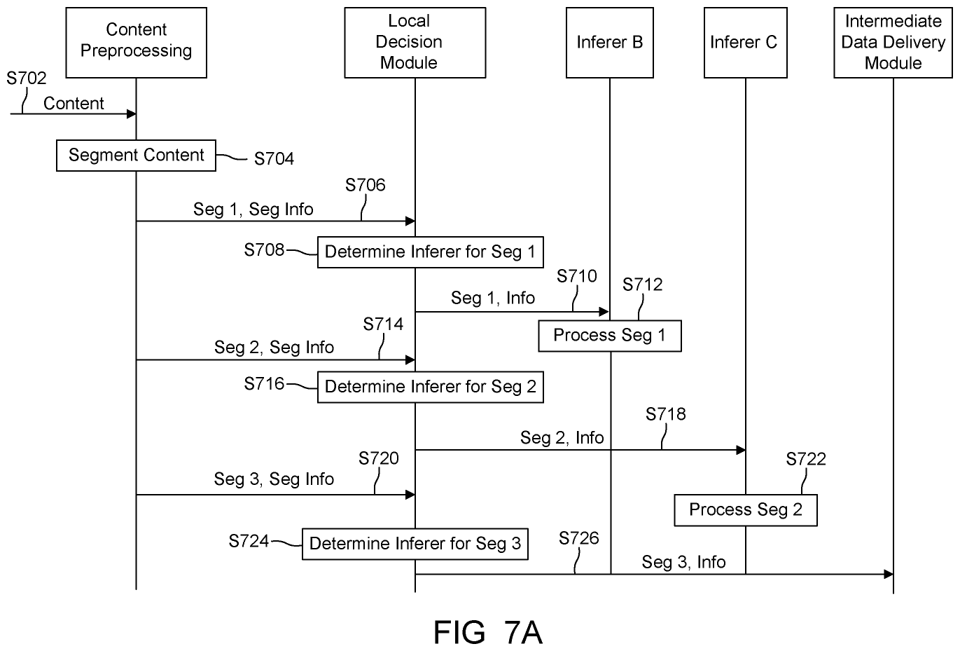

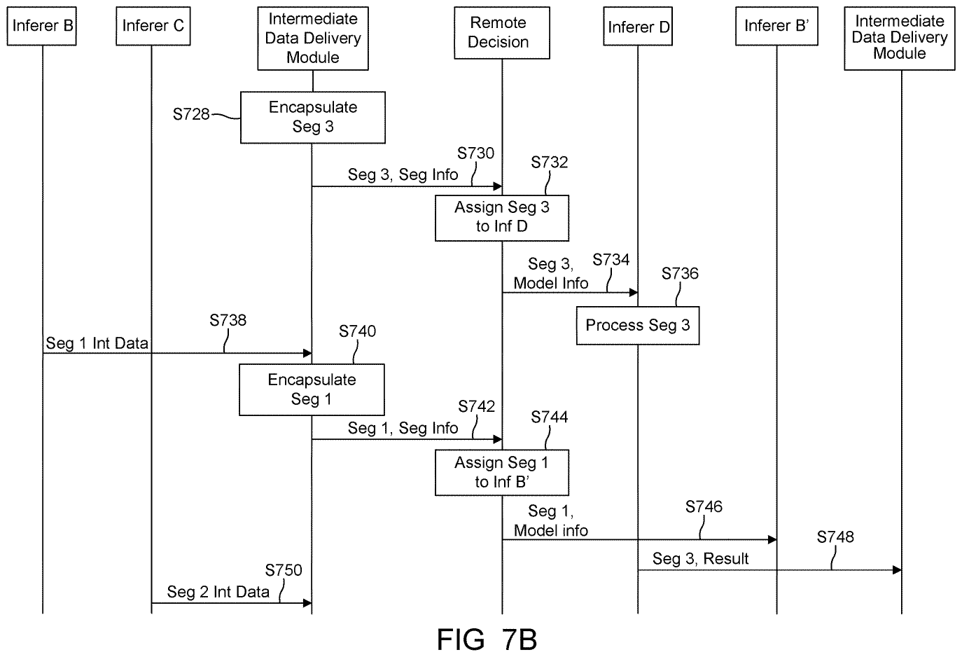

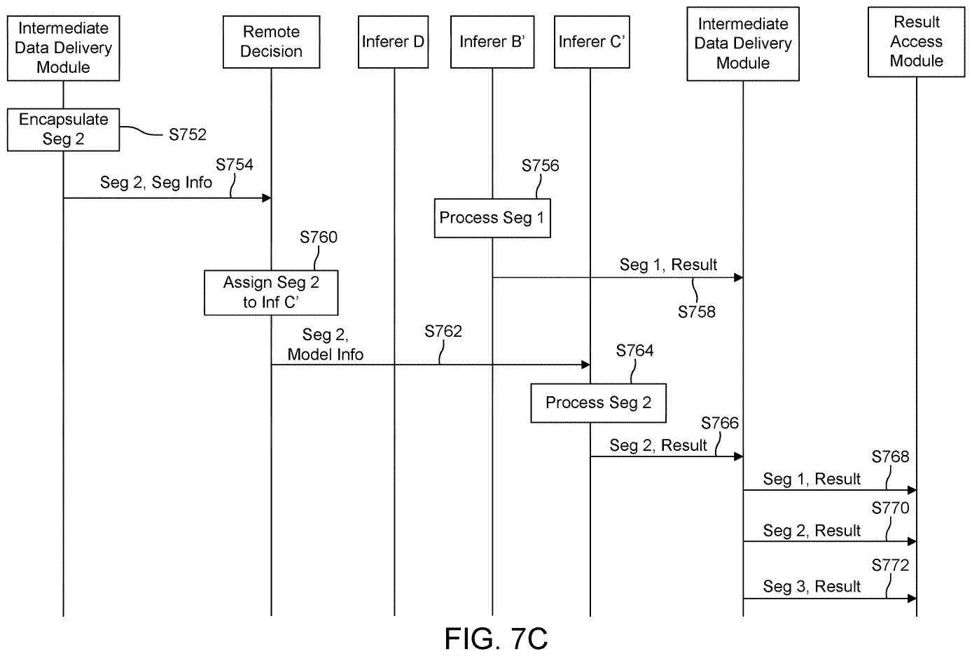

FIG. 7, made up of FIGS. 7A-7C, illustrates an embodiment of data flow of the example illustrated in FIG. 6.

In step S702, the content preprocessing module receives media content. The media content may have been captured by the UE.

In step S704, the content preprocessing module analyzes the received media content with respect to application, UE and network constraints, and segments the media content into segments, for example depending on the application configuration. The segmentation points may depend on the media content itself, for example when the camera shot changes or when an object is detected in an image. The content preprocessing module may enforce application constraints in segmenting the segment on a size basis. The content preprocessing module can provide information regarding the content for the local decision module, for example light/dark, moving pictures, etc.

In step S706, the content preprocessing module sends to the local decision module a first content segment, Seg 1, and segment information.

In step S708, the local decision module computes input information for Seg 1 as already described and determines which model is adapted and where to split the model for Seg 1. In the example, it is determined to assign a local inference module, Inf B, to do the inference on the subset of the model M up to the split point B applied to Seg 1.

In step S710, the local decision module forwards segment data to Inf B. The segment data includes segment information and model information for inference.

In step S712, Inf B processes the AI/ML subset applying input information received from the local decision module.

In step S714, the local decision module receives, possibly while still processing Seg 1, a second segment, Seg 2, from the content preprocessing module.

In step S716, similar to Step S708, the local decision module computes input information for Seg 2 and determines to assign it to a second local inference module, Inf C, to do the inference on the subset of the model M up to the split point C applied to Seg 2.

In step S718, as in step S710, segment data and related information on how to process Seg 2 are transferred to Inf C.

In step S720, independent of the processing of previous segments, Seg 1 and Seg 2, the local decision module receives a third segment, Seg 3, from the content preprocessing module.

In step S722, Inf B processes the AI/ML subset applying input information received from the local decision module. In general, the processing of an inferer is independent from other infererer. For example, Inf B may buffer the incoming segment while waiting for the previous segment to finish.

In step S724, the local decision function computes Seg 3 information and decides to forward Seg 3 to the network to apply the whole model or a variation of the model on it. Such a decision may be motivated by various conditions, for example i) no local inference module is available (in the example, the Inf B and Inf C have not completed their inferences), ii) the editorial information from the Seg 3 indicates that the processing may exceed the local remaining UE processing power to guarantee the latency requirements, and iii) the editorial information indicates that using a split model is not efficient.

In step S726, the local decision module transmits Seg 3 to the intermediate data delivery module along with information to wrap and encapsulate information (e.g., segment information, model information) together with the segment payload to the network side.

In step S728, the intermediate data delivery module encapsulates the Seg 3 segment data with additional information, as already described.

In step S730, the intermediate data delivery module transmits the encapsulated Seg 3 data to the intermediate access and remote decision module in the network.

In step S732, the intermediate access and remote decision module decapsulates packets, computes input information to get model and split point information for assigning a network inference module, Inf D, to process whole model upon receiving Seg 3.

In step S734, the intermediate access and remote decision module transmits Seg 3 and the additional information to Inf D.

In step S736, the network inference module Inf D processes the AI/ML subset applying input information received from the remote decision module and processes Model M for Seg 3.

In step S738, Inf B, having finished the processing of Seg 1, transmits the information to wrap and encapsulate useful information (Segment information, Model information) together with the segment intermediate data payload to the intermediate data delivery module.

In step S740, the intermediate data delivery module encapsulates the intermediate data associated with segment Seg 1 and additional information including the type of data (intermediate data).

In step S742, the intermediate data delivery module transmits encapsulated Seg 1 to the network side.

In step S744, similar to step S728, the intermediate access and remote decision module assigns a network inference module, Inf B′, for processing the remaining work starting from split point B of the model M on Seg 1.

In step S746, the intermediate access and remote decision module transmits Seg 1 and additional information to Inf B′.

In step S748, Inf D, having finalized the execution of the AI/ML model for Seg 3, transmits the segment result to the result delivery module in charge of reassembling, reordering the processed segments and delivering the result to the UE.

In step S750, Inf C transmits Seg 2 intermediate data to the intermediate data delivery module.

In step S752, the intermediate data delivery module encapsulates and transmits Seg 2 to the network side.

In step S754, the intermediate data delivery module transmits encapsulated Seg 2 to the network side.

In step S756, Inf B′ processes the AI/ML subset applying input information received from the remote decision module and starts processing the AI/ML model from split point B for Seg 1.

In step S758, Inf B′ transmits Seg 1 payload and information to the result delivery module.

In step S760, similar to step S740, the remote decision module assigns a network inference module Inf C′ for processing the remaining work starting from the split point C of the model M for Seg 2.

In step S762, the remote decision module transmits Seg 2 and additional information to Inf C′.

In step S764, Inf C′ processes the AI/ML subset from the split point C of Seg 2.

In step S766, Inf C′ transmits Seg 2 payload and information to the result delivery module.

In steps S768, S770 and S772, the result delivery module respectively transmits the result corresponding to the processed segments Seg 1, Seg 2, Seg 3 to the result access module in the UE.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method comprising in a first device:
partitioning a unit of media data corresponding to a media content item into a plurality of media segments; and
for each media segment:
determining a machine learning model, a machine learning part, and whether inference using the machine learning part is to be performed externally to the first device or by an inference unit of the first device, wherein the machine learning part is a subset of the machine learning model;
transmitting content data corresponding to the media segment and information indicative of the determined machine learning model and machine learning part for inference; and
obtaining processed data resulting from processing of the content data using at least the machine learning part.

2. (canceled)

3. The method of claim 1, wherein:
the determining is based on at least one of information associated with each media segment, capabilities of the first device, capabilities of a network to which the first device is connected, current network conditions, capabilities of inference units, requirements of an application for which the media content item is intended, model characteristics information, user specific requirements and task specific requirements.

4. (canceled)

5. The method of claim 1, further comprising:
concatenating result data corresponding to output of the machine learning model processing the content data corresponding to the media segments.

6. The method of claim 5, further comprising:
ordering the result data corresponding to the media segments prior to the concatenating.

7. The method of claim 1, further comprising, in case the processed data includes intermediate data received from a first inference unit:
transmitting the intermediate data and information indicative of the determined machine learning model and indicative of a machine learning part to be used for inference at a second inference unit.

8. The method of claim 7, wherein:
the first inference unit from which the processed data is received is internal to the first device and the second inference unit is external to the first device.

9. The method of claim 7, wherein:
the first inference unit from which the processed data is received is external to the first device and the second inference unit is internal to the first device.

10. The method of claim 1, wherein:
in case inference using the machine learning part is to be performed externally, the first device further transmits an identifier of the first device, the identifier associated with the transmitted content data.

11. The method of claim 1, wherein:
in case inference using the machine learning part is to be performed by an internal inference unit, the transmitting includes providing the content data corresponding to the media segment and the information indicative of the determined machine learning model and machine learning part for inference to the internal inference unit.

12. A first device comprising at least one hardware processor configured to:
partition a unit of media data corresponding to a media content item into a plurality of media segments; and
for each media segment:
determine a machine learning model, a machine learning part, and whether inference using the machine learning part is to be performed externally to the first device or by an inference unit of the first device, wherein the machine learning part is a subset of the machine learning model;
transmit content data corresponding to the media segment and information indicative of the determined machine learning model and machine learning part for inference; and
obtain processed data resulting from processing of the content data using at least the machine learning part.

13. (canceled)

14. The first device of claim 12, wherein:
the at least one hardware processor configured to determine a machine learning model, a machine learning part, and whether inference using the machine learning part is to be performed externally to the first device or by an inference unit of the first device based on at least one of information associated with each media segment, capabilities of the first device, capabilities of a network to which the first device is connected, current network conditions, capabilities of inference units, requirements of an application for which the media content item is intended, model characteristics information, user specific requirements and task specific requirements.

15. (canceled)

16. The first device of claim 12, wherein the at least one hardware processor is further configured to:
concatenate result data corresponding to output of the machine learning model processing the content data corresponding to the media segments.

17. The first device of claim 16, wherein the at least one hardware processor is further configured to:
order the result data corresponding to the media segments prior to the concatenating.

18. The first device of claim 12, wherein the at least one hardware processor is further configured to, in case the processed data includes intermediate data received from a first inference unit:
transmit the intermediate data and information indicative of the determined machine learning model and indicative of a machine learning part to be used for inference at a second inference unit.

19. The first device of claim 18, wherein:
the first inference unit from which the processed data is received is internal to the first device and the second inference unit is external to the first device.

20. The first device of claim 18, wherein:
the first inference unit from which the processed data is received is external to the first device and the second inference unit is internal to the first device.

21. The first device of claim 12, wherein the at least one hardware processor is further configured to:
in case inference using the machine learning part is to be performed externally, transmit an identifier of the first device, the identifier associated with the transmitted content data.

22. The first device of claim 12, wherein the at least one hardware processor is further configured to:
in case inference using the machine learning part is to be performed by an internal inference unit, provide the content data corresponding to the media segment and the information indicative of the determined machine learning model and machine learning part for inference to the internal inference unit.
